(19) United States
(12) Patent Application Publication
(10) Pub. No.: US 2025/0266519 A1
(43) Pub. Date: Aug. 21, 2025

(54) BATTERY MONITORING APPARATUS

(71) Applicant: DENSO CORPORATION, Kariya-city (JP)

(72) Inventor: Shoichiro IMANISHI, Kariya-city (JP)

(73) Assignee: DENSO CORPORATION, Kariya-city (JP)

(21) Appl. No.: 19/203,490

(22) Filed: May 9, 2025

Related U.S. Application Data
(63) Continuation of application No. PCT/JP2022/042098, filed on Nov. 11, 2022.

(51) Int. Cl. H01M 10/48; H01M 10/42; H01M 10/44

(52) U.S. Cl. CPC H01M 10/482; H01M 10/441; H01M 2010/4271

(57) ABSTRACT

In a battery monitoring apparatus, detection paths electrically connect respective unit batteries to a monitoring IC. At least one resistor is mounted on each detection path, and discharge switches are located to be closer to the monitoring IC than the at least one resistor is. Each detection path is arranged to extend from the monitoring IC to an edge of the circuit board. For at least one combination of two adjacent detection paths selected from all the detection paths, a center position of the at least one resistor mounted on one of the two adjacent detection paths is arranged to be offset relative to a center position of the at least one resistor mounted on the other of the two adjacent detection paths in a specific direction. The specific direction is defined as a direction from the monitoring IC toward the edge of the circuit board.

### CROSS REFERENCE TO RELATED APPLICATION

This application is a bypass continuation application of currently pending international application No. PCT/JP2022/042098 filed on Nov. 11, 2022 designating the United States of America, the entire disclosure of which is incorporated herein by reference.

### TECHNICAL FIELD

The present disclosure relates to battery monitoring apparatuses.

### BACKGROUND

A known battery monitoring apparatus, which is for example disclosed in Japanese Patent Application Publication No. 2008-67460, monitors the state of each of unit batteries connected in series. Such a battery monitoring apparatus includes a board, a monitoring integrated circuit (IC), and a plurality of detection paths mounted on the board. The monitoring IC monitors the state of each unit battery. The detection paths are provided to electrically connect the respective unit batteries to the monitoring IC. Resistors are mounted on the respective detection paths. A discharge switch is provided between each adjacent pair of the detection paths. The discharge switches are arranged to be closer to the monitoring IC than the resistors are. To equalize the states of charge of the unit batteries, a selected discharge switch corresponding to a unit battery is turned on.

### SUMMARY

Turn-on of the selected discharge switch results in a discharge current from the corresponding unit battery flowing through the resistors that constitute a closed circuit together with the selected discharge switch and the corresponding unit battery. The discharge current flowing through the resistors may cause the resistors to generate heat. For this reason, it is desirable to provide battery monitoring apparatuses, each of which is capable of preventing thermal damage to such a heat-sensitive monitoring IC.

From this viewpoint, the present disclosure seeks to provide battery monitoring apparatuses, each of which is capable of preventing thermal damage to a heat-sensitive monitoring IC.

The present disclosure provides a battery monitoring apparatus for monitoring a state of unit batteries connected in series. The battery monitoring apparatus includes a circuit board, a monitoring IC mounted on the circuit board and configured to monitor a state of each of the unit batteries, and a plurality of detection paths mounted on the circuit board. The detection paths electrically connect the respective unit batteries to the monitoring IC. The battery monitoring apparatus includes at least one resistor mounted on each detection path, and a plurality of discharge switches, each of which is arranged to connect between a corresponding adjacent pair of the detection paths. The discharge switches are located to be closer to the monitoring IC than the at least one resistor is.

Each of the detection paths is arranged to extend from the monitoring IC to an edge of the circuit board. For at least one combination of two adjacent detection paths selected from all the detection paths, a center position of the at least one resistor mounted on one of the two adjacent detection paths is arranged to be offset relative to a center position of the at least one resistor mounted on the other of the two adjacent detection paths in a specific direction. The specific direction is defined as a direction from the monitoring IC toward the edge of the circuit board.

Each of the detection paths is arranged to extend from the monitoring IC to an edge of the circuit board. For at least one combination of two adjacent detection paths selected from all the detection paths, the center position of the at least one resistor mounted on one of the two adjacent detection paths is arranged to be offset relative to the center position of the at least one resistor mounted on the other of the two adjacent detection paths in the specific direction defined as the direction from the monitoring IC toward the edge of the circuit board.

This configuration results in the mount positions of the resistors in the adjacent detection paths being more distributed as compared with a configuration that the center position of the at least one resistor mounted on one of the two adjacent detection paths is arranged to align with the center position of the at least one resistor mounted on the other of the two adjacent detection paths in the specific direction. This results in heat dissipation of each of the first to eighth resistors 51 to 58 increasing. This makes it possible to reduce the influence of heat generated in each resistor on such a heat-sensitive monitoring IC.

### BRIEF DESCRIPTION OF THE DRAWINGS

Other aspects of the present disclosure will become apparent from the following description of embodiments with reference to the accompanying drawings in which:

FIG. 1 is an overall structural view of a battery monitoring apparatus according to the first embodiment;

FIG. 2 is a plan view illustrating an arrangement of electronic components constituting the battery monitoring apparatus of the first embodiment;

FIG. 3 is an overall structural view of a battery monitoring apparatus according to the second embodiment;

FIG. 4 is a plan view illustrating an arrangement of electronic components constituting the battery monitoring apparatus of the second embodiment;

FIG. 5 is a plan view illustrating an arrangement of electronic components constituting a battery monitoring apparatus according to the third embodiment;

FIG. 6 is a plan view illustrating an arrangement of electronic components constituting a battery monitoring apparatus according to the fourth embodiment;

FIG. 7 is a timing chart illustrating how on-permission periods for discharge switches change over time;

FIG. 8 is a plan view illustrating an arrangement of electronic components constituting the battery monitoring apparatus according to the fifth embodiment;

FIG. 9 is a plan view illustrating an arrangement of electronic components constituting a battery monitoring apparatus according to the sixth embodiment;

FIG. 10 is a plan view illustrating an arrangement of electronic components constituting a battery monitoring apparatus according to the seventh embodiment;

FIG. 11 is a plan view illustrating an arrangement of electronic components constituting a battery monitoring apparatus according to one modification;

FIG. 12 is a plan view illustrating an arrangement of electronic components constituting a battery monitoring apparatus according to another modification;

FIG. 13 is a plan view illustrating an arrangement of electronic components constituting a battery monitoring apparatus according to a further modification; and

FIG. 14 is a plan view illustrating an arrangement of electronic components constituting a battery monitoring apparatus according to a still further modification.

### DETAILED DESCRIPTION OF EMBODIMENTS

The following describes exemplary embodiments of the present disclosure with reference to accompanying drawings. In the exemplary embodiments, functionally and/or structurally corresponding or associated components may be assigned identical reference characters or reference characters that differ by the order of hundreds.

When describing each functionally and/or structurally corresponding or associated component of a selected one of the exemplary embodiments, we can refer to the description of the corresponding functionally and/or structurally corresponding or associated component, which has been described in the other embodiments.

### First Embodiment

The following describes the first embodiment of the present disclosure, which embodies one of battery monitoring apparatuses according to the present disclosure. A battery monitoring apparatus 10 according to the first embodiment can be installed in a mobile object, such as an electric vehicle, a railway vehicle, an aircraft, or a ship. The battery monitoring apparatus 10 according to the first embodiment can be installed in stationary equipment.

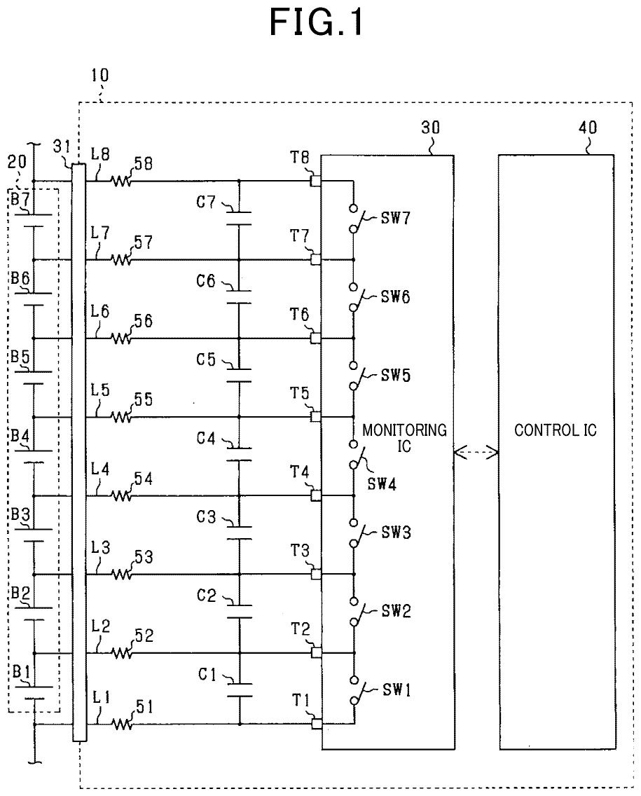

As illustrated in FIG. 1, the battery monitoring apparatus 10 includes a monitoring IC 30. The monitoring IC 30 is configured to monitor the state of each of unit batteries B1 to B7 that constitute a battery pack 20. The battery monitoring apparatus 10 includes a control IC 40 that is a higher-level IC than the monitoring IC 30. The unit batteries B1 to B7 of the battery pack 20 constitute a series-connected battery assembly. The number of the unit batteries of the battery pack 20 according to the first embodiment is 7 as an example. Each of the battery cells B1 to B7 is a single battery cell or an assembly of series-connected battery cells. Each battery cell is a chargeable and dischargeable storage battery, such as a lithium-ion secondary battery or a nickel-metal hydride secondary battery.

The battery monitoring apparatus 10 includes, as a configuration for electrically connecting between the monitoring IC 30 and each unit battery B1 to B7, first to eighth detection paths L1 to L8 and a connector 31. Each of the first to eighth detection paths L1 to L8 has opposing first and second ends. The first end of each of the first to eighth detection paths L1 to L8 is connected to the monitoring IC 30, and the second end of each of the first to eighth detection paths L1 to L8 is connected to the connector 31.

The monitoring IC 30 has first to eighth terminals T1 to T8. Each unit battery B1 to B7 has a positive terminal and a negative terminal. The positive terminal of the i-th unit battery Bi, where i is an integer of any one of 1, 2, 3, 4, 5, 6, 7, is connected to the (i+1) th terminal Ti+1 of the monitoring IC 30 through the detection path Li+1 and the connector 31. The negative terminal of the i-th unit battery Bi is connected to the i-th terminal Ti of the monitoring IC 30 through the i-th detection path Li and the connector 31.

Each of the second to sixth detection paths except for the first and eighth detection paths for a corresponding adjacent pair of high-and low-potential unit batteries is configured to be shared as the positive-terminal side detection path of the low-potential unit battery and the negative-terminal side detection path of the high-potential unit battery. That is, the (i+1) th detection path Li+1, where i is an integer of any one of 1 to 6, for an adjacent pair of unit batteries Bi and Bi+1 serves as a common detection path connected to the positive terminal of the unit battery Bi and the negative terminal of the unit battery Bi+1.

The battery monitoring apparatus 10 includes a circuit board 70 and first to eighth resistors 51 to 58 mounted on the respective first to eighth detection paths L1 to L8. Each of the first to eighth resistors 51 to 58, which has opposing first and second ends, is, for example, a chip resistor. The first to eighth resistors 51 to 58 according to the first embodiment have predetermined resistance values that are substantially identical to one another, more specifically, that are exactly identical to one another. Let us describe the first detection path L1 as an example. The first detection path L1 is comprised of a first connection pattern that electrically connects between the first end of the first resistor 51 and the first terminal T1, and a second connection pattern that electrically connects between the second end of the first resistor 51 and the connector 31. The first and second connection patterns of each detection path Li are mounted to the circuit board 70. The circuit board 70 will be described later.

The battery monitoring apparatus 10 includes first to seventh capacitors C1 to C7. Each of the first to seventh capacitors C1 to C7 is, for example, a chip capacitor. The first to seventh capacitors C1 to C7 according to the first embodiment have predetermined capacitance values that are substantially identical to one another, more specifically, that are exactly identical to one another. The i-th capacitor Ci has a high-potential terminal and a low-potential terminal.

Each detection path L1 to L8 has a first portion located between the corresponding resistor and the corresponding terminal and a second portion that is the remaining portion. The high-potential terminal of the i-th capacitor Ci is connected to the first portion of the (i+1) th detection path Li+1. That is, the i-th capacitor Ci is arranged to connect between the (i+1) th detection path Li+1 and the i-th detection path Li located adjacent to the (i+1) th detection path Li+1.

Let us describe the first unit battery B1 as an example. The terminal voltage across the first unit battery Bi is inputted to the monitoring IC 30 through the first and second detection paths L1 and L2 and a lowpass filter that is comprised of the first resistor 51 and the first capacitor C1. The lowpass filter for each unit battery Bi is provided to remove high-frequency noise superimposed on a signal of the terminal voltage signal across the unit battery Bi to accordingly increase the detection accuracy of the terminal voltage across the unit battery Bi.

The battery monitoring apparatus 10 includes first to seventh discharge switches SW1 to SW7 provided for the respective unit batteries B1 to B7. The first to seventh discharge switches SW1 to SW7 are provided to equalize the states of charge (SOCs) of the first to seventh batteries B1 to B7. Each discharge switch SW1 to SW7 is configured to enable current flow therethrough when turned on, and disable bidirectional current flow therethrough when turned off. The discharge switches SW1 to SW7 according to the first embodiment are installed in the monitoring IC 30. The i-th discharge switch SWi is arranged to connect between the (i+1) th terminal Ti+1 and the i-th terminal Ti. That is, the i-th discharge switch SWi is arranged to electrically connect between the (i+1) th detection path Li+1 and the i-th detection path Li.

The control IC 40 serves as a main controller that carries out overall control of, for example, (i) state monitoring of each unit battery B1 to B7 and (ii) SCO equalization of the unit batteries B1 to B7. Specifically, the control IC 40 is configured to send, to the monitoring IC 30 serving as a sub controller, instructions that instruct the monitoring IC 30 to perform one or more tasks related to (i) the state monitoring of each unit battery B1 to B7 and (ii) the SCO equalization of the unit batteries B1 to B7. The monitoring IC 30 is configured to monitor the terminal voltage across each unit battery B1 to B7, and send, to the control IC 40, the monitored terminal voltage across each unit battery B1 to B7.

The monitoring IC 30 is configured to select, in response to receiving the instructions sent from the control IC 40, at least one unit battery from the unit batteries B1 to B7 as at least one discharge target for SCO equalization. Then, the monitoring IC 30 is configured to turn on at least one discharge switch corresponding to the at least one selected unit battery for a predetermined period. For example, turning on the first discharge switch SW1 results in a discharge current outputted from the first unit battery B1 flowing through a closed circuit constituted by the first unit battery B1, the second detection path L2 including the second resistor 52, the first discharge switch SW1, and the first detection path L1 including the first resistor 51. The discharge current flowing through the closed circuit results in the first and second resistors 51 and 52 generating heat.

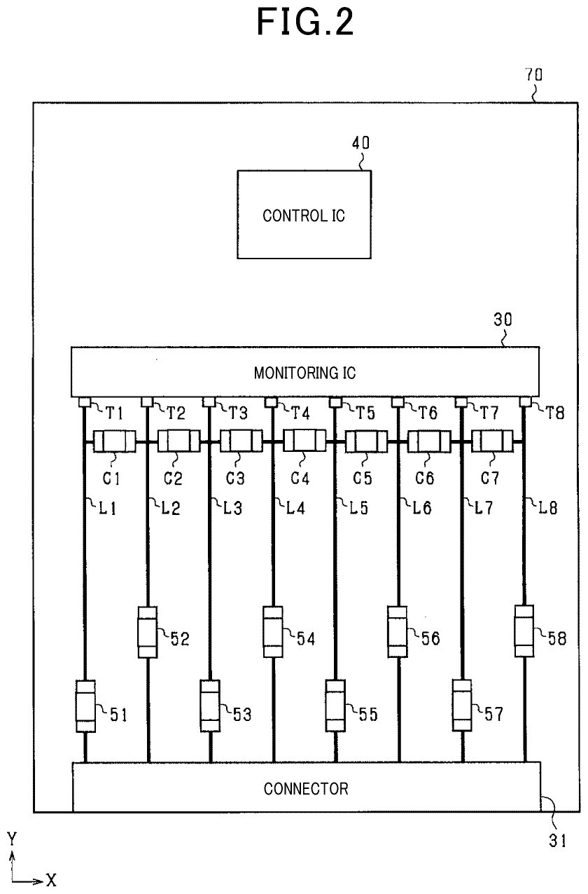

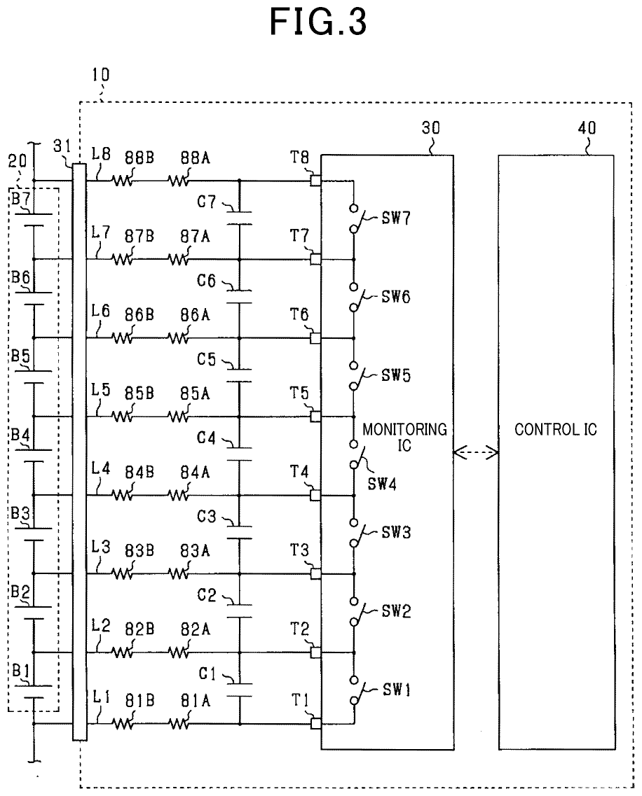

The following describes improvements of the battery monitoring apparatus 10 for enhancing heat dissipation with reference to FIG. 2.

FIG. 2 is a view illustrating an example of the arrangement of the electronic components of the battery monitoring apparatus 10.

The battery monitoring apparatus 10 includes, as illustrated in FIG. 2, the circuit board 70. The circuit board 70 has opposing major surfaces, and the electronic components including, for example, the monitoring IC 30 and the resistors 51 to 58 are mounted on a first surface that is a selected one of the major surfaces of the circuit board 70. The circuit board 70 is a printed circuit board, and is configured as a rectangular plate-shaped circuit board. In FIG. 2, the X direction is defined as a direction in which the short sides of the circuit board 70 extend, and the Y direction is defined as a direction in which the long sides of the circuit board 70 extend. The X direction is perpendicular to the Y direction.

The first surface of the circuit board 70 has opposing first and second edges located adjacent to the respective short sides of the circuit board 70. The connector 31 is mounted on the first edge of the first surface of the circuit board 70. The connector 31 is arranged to extend along the first edge of the first surface of the circuit board 70.

The control IC 40 is mounted on the first surface of the circuit board 70 to be separated from the connector 31 in the Y direction. The monitoring IC 30 mounted on the first surface of the circuit board 70 is arranged between the connector 31 and the control IC 30 in the Y direction. The monitoring IC 30 has a flat rectangular-parallelepiped shape, i.e., has a rectangular shape in plan view. For example, the monitoring IC 30 according to the first embodiment has a rectangular-parallelepiped shape elongated in the X direction.

The monitoring IC 30 has a portion, i.e., a facing portion, that faces the connector 31, and the first to eighth terminals T1 to T8 of the monitoring IC 30 are mounted on the facing portion of the monitoring IC 30.

The first to eighth detection paths L1 to L8 are arranged to extend from the respective first to eighth terminals T1 to T8 to the connector 31 mounted on the first edge of the first surface of the circuit board 70. The first to eighth detection paths L1 to L8 according to the first embodiment are arranged to extend linearly in the Y direction. The first to eighth detection paths L1 to L8 are arranged on the first surface of the circuit board 70 at intervals along the X direction.

The first to seventh capacitors C1 to C7 are mounted on a portion of the first surface of the circuit board 70; the portion is arranged to be closer to the connector 31 than the monitoring IC 30 is. The first to seventh capacitors C1 to C7 are arranged in the X direction.

Each of the first to eighth resisters 51 to 58 has an elongated shape, more particularly, a rectangular-parallelepiped shape. Each of the first to eighth resistors 51 to 58 is mounted on the first surface of the circuit board 70 while the longitudinal direction of the corresponding one of the first to eighth resistors 51 to 58 is parallel to the direction, i.e., the Y direction, in which the corresponding detection path on which the corresponding one of the first to eighth resistors 51 to 58 is mounted.

The first, third, fifth, and seventh resistors 51, 53, 55, and 57 are arranged in the X direction, and the second, fourth, sixth, and eighth resistors 52, 54, 56, and 58 are arranged in the X direction while being offset toward the monitoring IC 30 in the Y-direction relative to the positions of the first, third, fifth, and seventh resistors 51, 53, 55, and 57.

In the first embodiment, let us consider each combination of two adjacent detection paths selected from the first to eighth resistors 51 to 58. For each combination of two adjacent detection paths selected from the first to eighth detection paths L1 to L8, the center position of the resistor mounted on one of the two adjacent detection paths is arranged to be offset in the Y direction, which serves as a specific direction, relative to the center position of the resistor mounted on the other of the two adjacent detection paths.

Specifically, the following describes in detail the pair of the first and second detection paths L1 and L2 as an example.

The center position of the first resistor 51 mounted on the first detection path L1 is arranged to be offset in the Y direction relative to the center position of the second resistor 52 mounted on the second detection path L2. That is, the center position of the first resistor 51 is shifted in the Y direction relative to the center position of the second resistor 52. The arrangement of the corresponding resistors of each pair of the second and third resistors L2 and L3, the third and fourth resistors L3 and L4, the fourth and fifth resistors L4 and L5, the fifth and sixth resistors L5 and L6, the sixth and seventh resistors L6 and L7, and the seventh and eighth resistors L7 and L8 is configured to be identical to the arrangement of the first and second resistors 51 and 52 of the pair of the first and second detection paths L1 and L2.

The above specific arrangement of the first to eighth resistors 51 to 58 results in the mount positions of the resistors in the adjacent detection paths being distributed on the first surface of the circuit board 70, resulting in heat dissipation of each of the first to eighth resistors 51 to 58 increasing. This therefore makes it possible to reduce the influence of heat generated in each of the first to eighth resistors 51 to 58 on the monitoring IC 30, thus preventing degradation of the voltage detection accuracy of the monitoring IC 30.

In particular, for each combination of two adjacent detection paths selected from the first to eighth detection paths L1 to L8, the position of the resistor mounted on one of the two adjacent detection paths does not overlap the position of the resistor mounted on the other of the two adjacent detection paths in the X direction.

Specifically, the following describes in detail the pair of the first and second detection paths L1 and L2 as an example.

The position of the first resistor 51 mounted on the first detection path L1 does not overlap the position of the second resistor 52 mounted on the second detection path L2 in the X direction, resulting in the first end of the first resistor 51 connected to the monitoring IC 30 being separated from the second end of the second resistor 52 connected to the connector 31 in the Y direction. In other words, the mount position of the first resistor 51 on the first surface of the circuit board 70 is non-overlapping with the mount position of the second resistor 52 thereon in the X direction that is perpendicular to the longitudinal direction of the first resistor 51 along the first surface of the circuit board 70. The arrangement of the corresponding resistors of each pair of the second and third resistors L2 and L3, the third and fourth resistors L3 and L4, the fourth and fifth resistors L4 and L5, the fifth and sixth resistors L5 and L6, the sixth and seventh resistors L6 and L7, and the seventh and eighth resistors L7 and L8 is configured to be identical to the arrangement of the first and second resistors 51 and 52 of the pair of the first and second detection paths L1 and L2.

This arrangement of the resistors of each combination of two adjacent detection paths selected from the first to eighth detection paths L1 to L8 makes it possible to further enhance the heat dissipation of each of the first to eighth resistors 51 to 58.

The first to eighth resistors 51 to 58 are mounted on the first edge of the first surface of the circuit board 70. The heat dissipation of the edges of the circuit board 70 is higher, making it possible to enhance the heat dissipation of each of the first to eighth resistors 51 to 58.

### Second Embodiment

The following describes the second embodiment of the present disclosure while focusing on the different points of the second embodiment from the first embodiment with reference to the accompanying drawings.

The battery monitoring apparatus 10 of the second embodiment includes plural resistors mounted on each of the first to eighth detection paths L1 to L8. The resistors of the first to eighth detection paths L1 to L8 according to the second embodiment have predetermined resistance values that are substantially identical to one another, more specifically, that are exactly identical to one another.

A first-A resistor 81A and a first-B resistor 81B are mounted on the first detection path L1, a second-A resistor 82A and a second-B resistor 82B are mounted on the second detection path L2, and a third-A resistor 83A and a third-B resistor 83B are mounted on the third detection path L3. A fourth-A resistor 84A and a fourth-B resistor 84B are mounted on the fourth detection path L4, a fifth-A resistor 85A and a fifth-B resistor 85B are mounted on the fifth detection path L5, and a sixth-A resistor 86A and a sixth-B resistor 86B are mounted on the sixth detection path L6. A seventh-A resistor 87A and a seventh-B resistor 87B are mounted on the seventh detection path L7, and an eighth-A resistor 88A and an eighth-B resistor 88B are mounted on the eighth detection path L8.

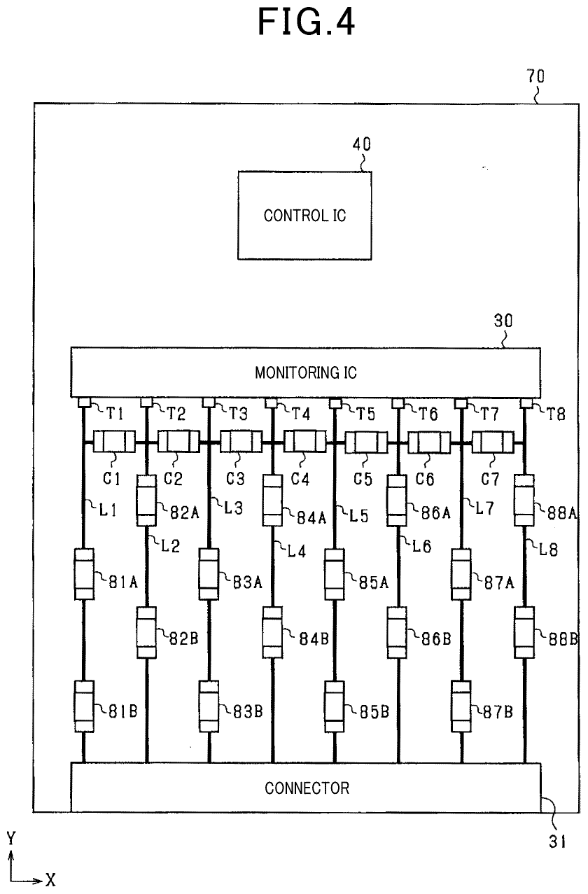

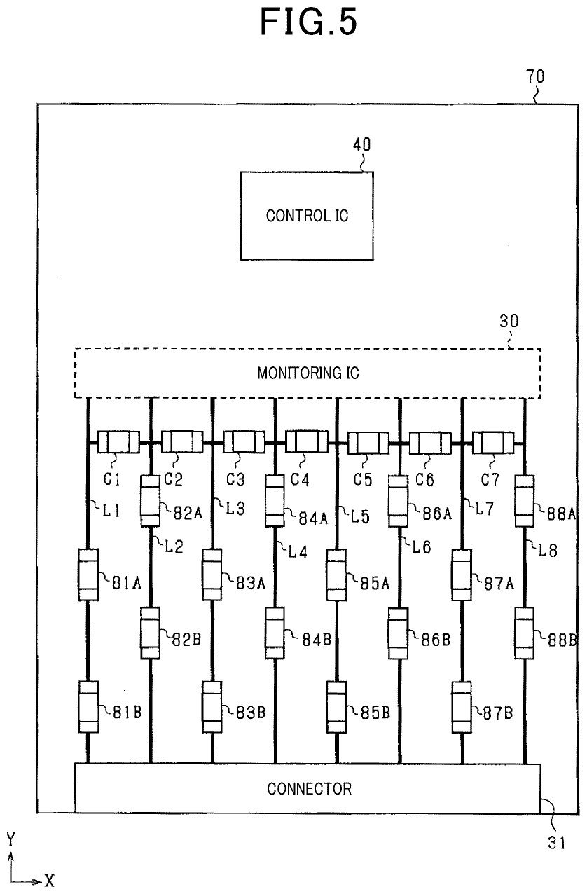

FIG. 4 is a view illustrating an example of the arrangement of the electronic components of the battery monitoring apparatus 10 according to the second embodiment.

Each of the first-A to eighth-B resistors 81A, 81B, 82A, 82B, 83A, 83B, 84A, 84B, 85A, 85B, 86A, 86B, 87A, 87B, 88A, and 88B has a rectangular-parallelepiped shape and is mounted on the first surface of the circuit board 70 while the longitudinal direction of the corresponding one of the first-A to eighth-B resistors is parallel to the Y direction.

On the first detection path L1, the first-A resistor 81A is mounted to be closer to the monitoring IC 30 than the first-B resistor 81B is. The arrangement of the resistors on each of the remaining detection paths L2 to L8 is identical to that of the resistors 81A and 81B on the first detection paths L1.

The following describes the first detection path L1 selected from the first to eighth detection paths L1 to L8 as an example.

The resistance value of each of the first-A and first-B resistors 81A and 81B is set to be half the resistance value of the first resistor 51 of the first embodiment. This results in the amount of heat generated in each of the first-A and first-B resistors 81A and 81B being less than the amount of heat generated in the first resistor 51 of the first embodiment.

For each combination of two adjacent detection paths selected from the first to eighth detection paths L1 to L8, the positions of the resistors mounted on one of the two adjacent detection paths do not overlap the positions of the resistors mounted on the other of the two adjacent detection paths in the X direction. This results in heat dissipation of each of the first-A to eighth-B resistors 81A, 81B, 82A, 82B, 83A, 83B, 84A, 84B, 85A, 85B, 86A, 86B, 87A, 87B, 88A, and 88B increasing, making it possible to prevent degradation of the voltage detection accuracy of the monitoring IC 30.

### Modification of Second Embodiment

Three or more resistors can be mounted on each of the first to eighth detection paths L1 to L8.

### Third Embodiment

The following describes the third embodiment of the present disclosure while focusing on the different points of the third embodiment from the second embodiment with reference to the accompanying drawing.

In each of the first and second embodiments, the electronic components, which include the monitoring IC 30, the control IC 40, each resistor, and each capacitor, are mounted on the same first surface of the circuit board 70. In contrast, the control IC 40, the first-A to eighth-B resistors 81A, 81B, 82A, 82B, 83A, 83B, 84A, 84B, 85A, 85B, 86A, 86B, 87A, 87B, 88A, and 88B, and the first to seventh capacitors C1 to C7 are mounted on the first surface of the circuit board 70, and the monitoring IC 30 is mounted on the second surface of the circuit board 70; the second surface is opposite to the first surface. Each of the first to eighth detection paths L1 to L8 and the corresponding one of the terminals T1 to T8 of the monitoring IC 30 may be electrically connected to one another through a corresponding one of vias formed through the circuit board 70.

Plural resistors are mounted along each detection path L1 to L8, resulting in the arrangement space of the resistors on the first surface of the circuit board 70 being greater in the Y direction. Arrangement of the monitoring IC 30 on the first surface of the circuit board 70 may cause the resistors 81A to 88B to be close to the monitoring IC 30. This may increase the influence of heat generated in each of the resistors 81A to 88B on the monitoring IC 30.

From this viewpoint, the above configuration of the battery monitoring apparatus 10 according to the third embodiment enables the monitoring IC 30 to be less subject to heat generated in each resistor, making it possible to prevent degradation of the voltage detection accuracy of the monitoring IC 30. Additionally, arrangement of the monitoring IC 30 on the second surface of the circuit board 70 enables a separation distance between corresponding two resistors mounted on each of the first to eighth detection paths L1 to L8 to be greater, resulting in the heat dissipation of each of the resistors 81A to 88B increasing.

### Fourth Embodiment

The following describes the fourth embodiment of the present disclosure while focusing on the different points of the fourth embodiment from the second embodiment with reference to the accompanying drawing.

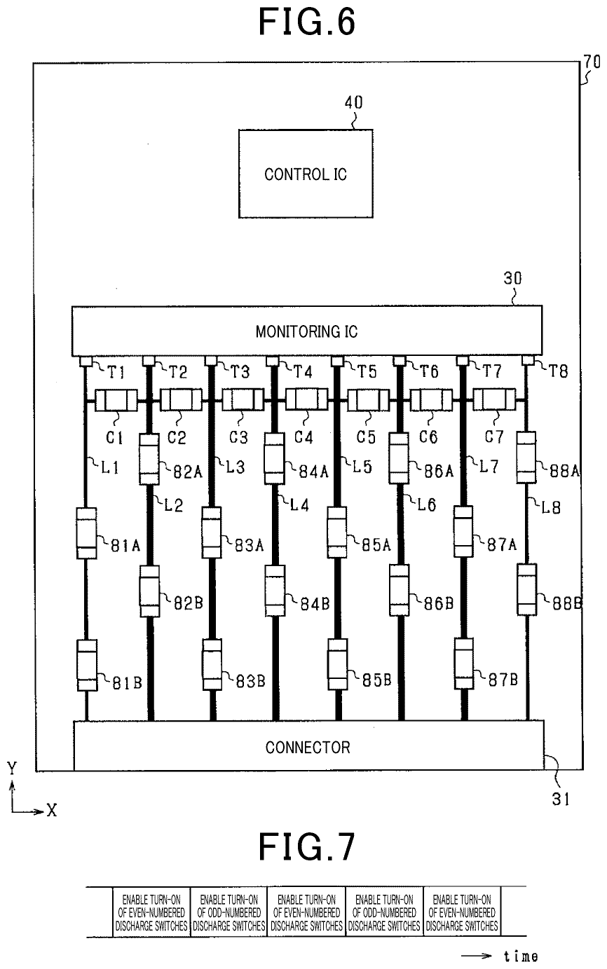

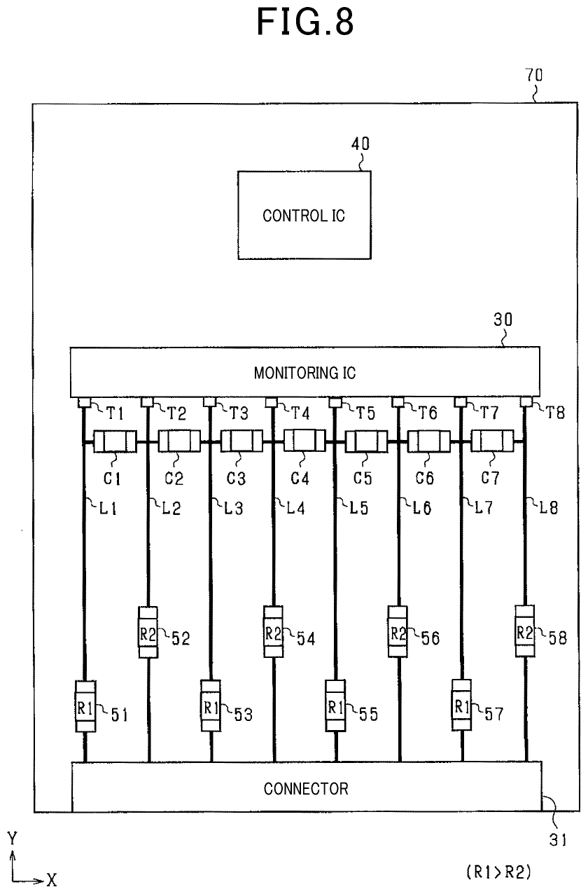

The width of each of the second to seventh detection paths L2 to L7 according to the fourth embodiment is, as illustrated in FIG. 6, set to be greater than the width of each of the outermost first and eighth detection paths L1 and L8. This configuration aims to improve the heat dissipation of the resistors on the second to seventh detection paths L2 to L7 in view of a predetermined switching procedure of the first to seventh discharge switches SW1 to SW7.

Specifically, the monitoring IC 30 of the fourth embodiment is configured to alternately establish a first period and a second period.

During the first period, the monitoring IC 30 enables turn-on of at least one of the first, third, fifth, and seventh discharge switches SW1, SW3, SW5, and SW7 corresponding to the odd-numbered unit batteries, i.e., the first, third, fifth, and seventh unit batteries B1, B3, B5, and B7, among the unit batteries B1 to B8; the odd-numbered unit batteries are countered from the lowest-or highest-potential unit battery B1 or B7.

During the second period, the monitoring IC 30 enables turn-on of at least one of the second, fourth, and sixth discharge switches SW2, SW4, and SW6 corresponding to the even-numbered unit batteries, i.e., the second, fourth, and sixth unit batteries B2, B4, and B6, among the unit batteries B1 to B8; the even-numbered unit are counted from the lowest-or highest-potential unit battery B1 or B7.

The monitoring IC 30 is configured to select, during the first period, at least one of the first, third, fifth, and seventh unit batteries B1, B3, B5, and B7, which has a relatively high SOC, and turn on the at least one discharge switch corresponding to the at least one selected unit battery during the first period. The monitoring IC 30 is configured to additionally select, during the second period, at least one of the first, third, fifth, and seventh unit batteries B2, B4, and B6, which has a relatively high SOC, and turn on the at least one discharge switch corresponding to the at least one selected unit battery during the second period.

The detection paths through which a discharge current can flow during the first period are the first to eighth detection paths L1 to L8. In contrast, the detection paths through which a discharge current can flow during the second period are the second to seventh detection paths L2 to L8 in the first to eighth detection paths L1 to L8. That is, the frequency at which the resistors 52 to 57 on the second to seventh detection paths L2 to L7 generate heat is higher than the frequency at which the resistors 51 and 58 on the first and eighth detection paths L2 and L8. For this reason, to increase the heat-dissipation area of each of the second to seventh detection paths L2 to L7 to be greater than the heat-dissipation area of each of the first and eighth detection paths L1 and L8, the width of each of the second to seventh detection paths L2 to L7 according to the fourth embodiment is set to be greater than the width of each of the outermost first and eighth detection paths L1 and L8. This configuration enables the heat dissipation of the resistors on the second to seventh detection paths L2 to L7 to be higher.

Preferably, the width of each of the second to seventh detection paths L2 to L7 according to the fourth embodiment may be set to be 1.5 to 2 times or 1.5 to 2.5 times greater than the width of each of the outermost first and eighth detection paths L1 and L8.

### Fifth Embodiment

The following describes the fifth embodiment of the present disclosure while focusing on the different points of the fifth embodiment from the first embodiment with reference to the accompanying drawing.

The second, fourth, sixth, and eighth resistors 52, 54, 56, and 58, which are relatively closer to the monitoring IC 30 than the remaining resistors 51, 53, 55, and 57 are in the Y direction, have a resistance value R2. Similarly, the first, third, fifth, and seventh resistors 51, 53, 55, and 57, which are relatively farther away from the monitoring IC 30 than the remaining resistors 52, 54, 56, and 58 are in the Y direction, have a resistance value R1. The resistance value R2 is set to be smaller than the resistance value R1.

The smaller the resistance value of a resistor, the smaller the amount of heat generated in the resistor through which a current is flowing. From this viewpoint, the resistors 52, 54, 56, and 58, which relatively generate a smaller amount of heat than the remaining resistors 51, 53, 55, and 57 do, are arranged to be closer to the monitoring IC 30 than the remaining resistors 51, 53, 55, and 57 are. This efficiently reduce the influence of heat generated in each of the first to eighth resistors 51 to 58.

The first, third, fifth, and seventh resistors 51, 53, 55, and 57, which relatively generate a greater amount of heat than the remaining resistors 52, 54, 56, and 58 do, are arranged to be closer to the first edge of the circuit board 70, which have a higher level of heat dissipation. This therefore makes it possible to efficiently reduce the influence of heat generated in the first, third, fifth, and seventh resistors 51, 53, 55, and 57 on the monitoring IC 30.

### Sixth Embodiment

The following describes the sixth embodiment of the present disclosure while focusing on the different points of the sixth embodiment from the second or fifth embodiment with reference to the accompanying drawing. The battery monitoring apparatus 10 of the sixth embodiment is configured such that the characteristics of the lowpass filters for the unit batteries B1 to B7 are identical to one another.

The resistors 81A, 82A, 83A, 84A, 85A, 86A, 87A, and 88A, which are relatively closer to the monitoring IC 30 in the Y direction, in the resistors 81A, 81B, . . . , 87A, 87B, 88A, and 88B constitute a first resistor group. The resistors 81B, 82B, 83B, 84B, 85B, 86B, 87B, and 88B, which are relatively farther away from the monitoring IC 30 in the Y direction, in the resistors 81A, 81B, . . . , 87A, 87B, 88A, and 88B constitute a second resistor group. The resistors 81A to 88A of the first resistor group have a resistance value R2, and the resistors 81B to 88B of the second resistor group, and the resistance value R2 is set to be lower than the first resistance value. The sum of the resistance values R1 and R2, which will be referred to as a total resistance value (R1+R2) of each detection path L1 to L8 will be referred to as a total resistance value (R1+R2). The total resistance values (R1+R2) of the detection paths L1 to L8 are set to be substantially to one another, more specifically, are exactly identical to one another. This enables the characteristics of the lowpass filters for the unit batteries B1 to B7 to be identical to one another.

### Modifications of Sixth Embodiment

Three or more resistors can be mounted on each of the first to eighth detection paths L1 to L8 according to the sixth embodiment.

The closer one of the resistors mounted on each detection path L1 to L8 to the monitoring IC 30, the smaller the resistance value of the one of the resistors mounted on the corresponding detection path L1 to L8 according to the sixth embodiment.

Like the third embodiment, the monitoring IC 30 according to the sixth embodiment may be mounted on the second surface of the circuit board 70.

At least two capacitances of at least two of the capacitors C1 to C8 may be set to be different from one another.

### Seventh Embodiment

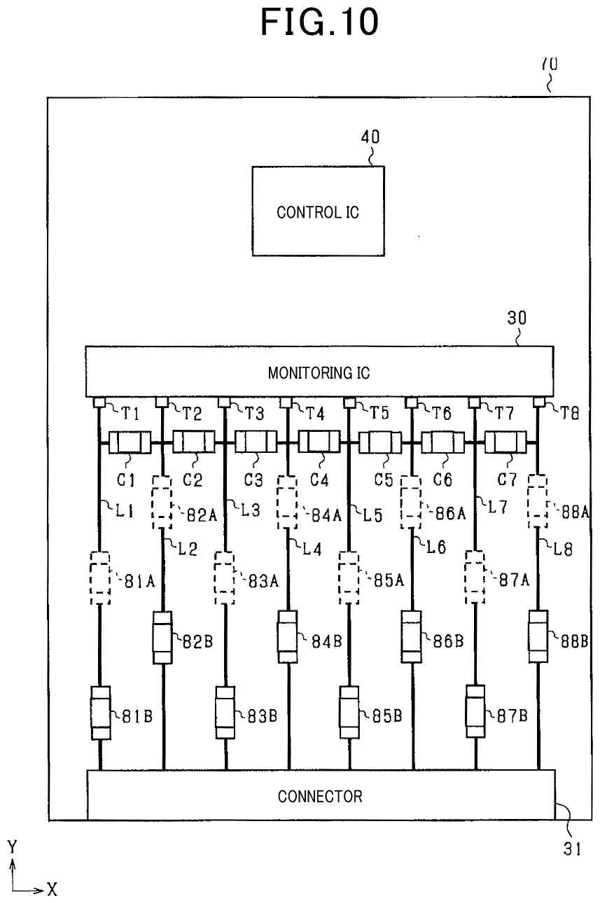

The following describes the seventh embodiment of the present disclosure while focusing on the different points of the seventh embodiment from the second, fifth, or sixth embodiment with reference to the accompanying drawing. The first-A, second-A, third-A, fourth-A, fifth-A, sixth-A, seventh-A, and eighth-A resistors 81A, 82A, 83A, 84A, 85A, 86A, 87A, and 88A are, as illustrated in FIG. 10, mounted on the second surface of the circuit board 70; the second surface is opposite to the first surface of the circuit board 70.

Plural resistors are mounted along each detection path L1 to L8, resulting in the arrangement space of the resistors on the first surface of the circuit board 70 being greater in the Y direction. This may result in the first-A, second-A, . . . , and eighth-A resistors 81A, 82A, . . . , and 88A to be close to the monitoring IC 30. This may increase the influence of heat generated in each of the first-A, second-A, . . . , and eighth-A resistors 81A, 82A, . . . , and 88A on the monitoring IC 30.

In contrast, the battery monitoring apparatus 10 of the seventh embodiment, which includes the first-A, second-A, . . . , and eighth-A resistors 81A, 82A, . . . , and 88A mounted on the second surface of the circuit board 70, enables the monitoring IC 30 to be less subject to heat generated in each of the first-A, second-A, . . . , and eighth-A resistors 81A, 82A, . . . , and 88A, making it possible to prevent degradation of the voltage detection accuracy of the monitoring IC 30.

### Other Modifications

Each of the first to seventh embodiment can be modified as follows.

Like the fourth embodiment, the width of each of the second to seventh detection paths L2 to L7 according to the seventh embodiment is, as illustrated in FIG. 10, set to be greater than the width of each of the outermost first and eighth detection paths L1 and L8.

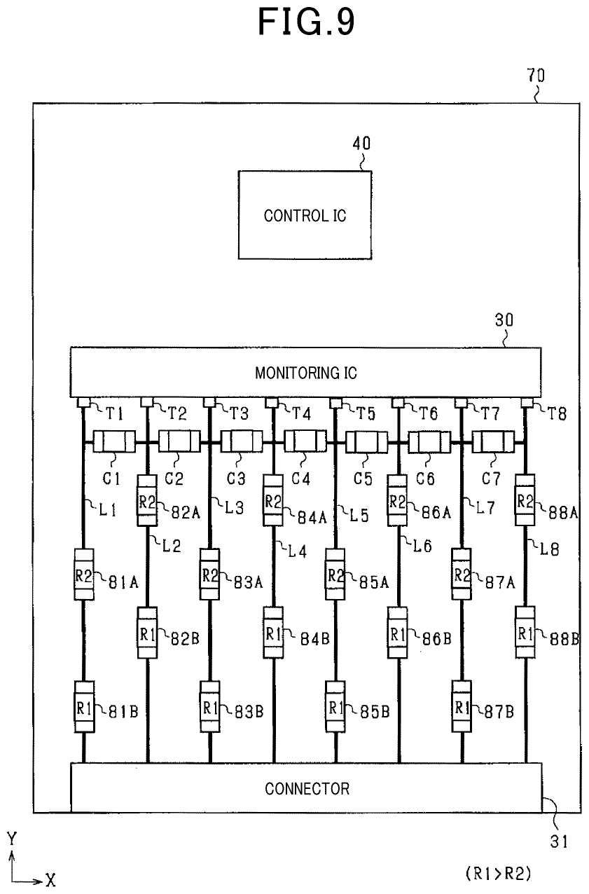

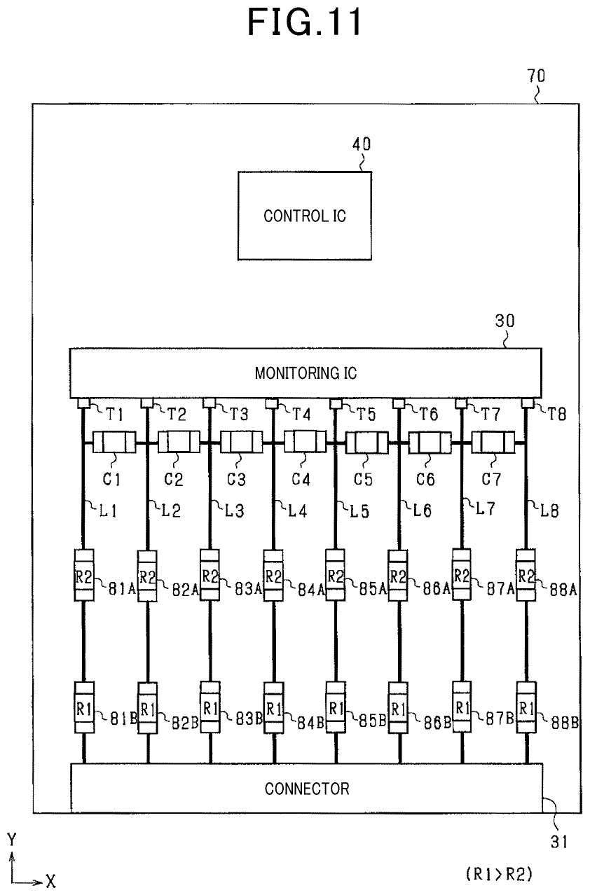

For each combination of two adjacent detection paths selected from the first to eighth detection paths L1 to L8 illustrated in FIG. 9, the center position of the resistor mounted on one of the two adjacent detection paths may be aligned with the center position of the resistor mounted on the other of the two adjacent detection paths. The configuration of this modification is illustrated in FIG. 11. At least two capacitances of at least two of the capacitors C1 to C8 illustrated in FIG. 11 may be set to be different from one another.

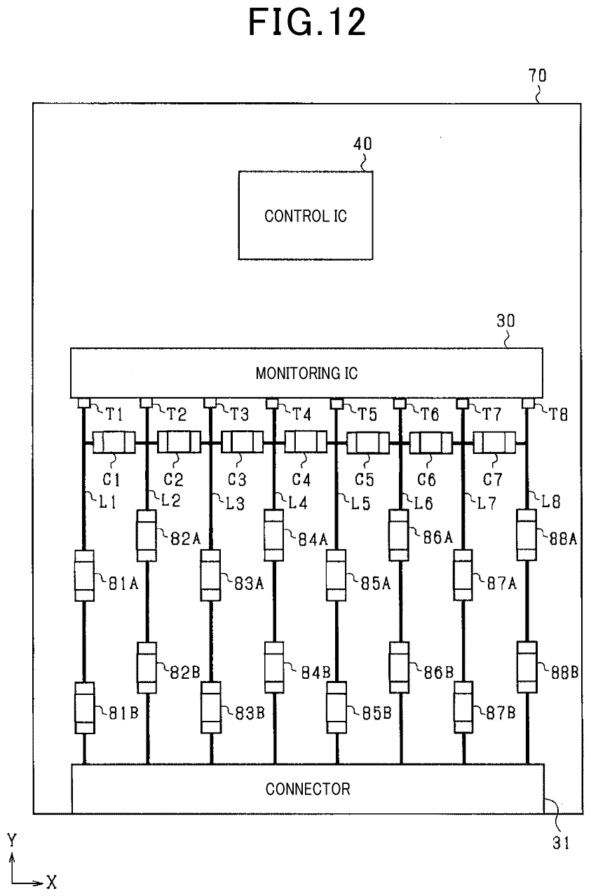

For each combination of two adjacent detection paths selected from the first to eighth detection paths L1 to L8, a part of the resistor mounted on one of the two adjacent detection paths may overlap a part of the resistor mounted on the other of the two adjacent detection paths in the X direction (see FIG. 12).

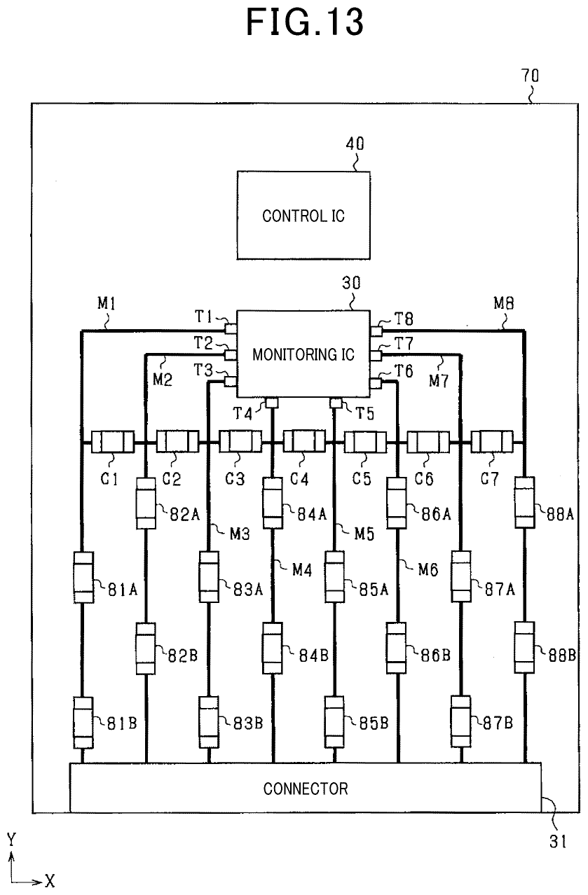

Detection paths are not limited to the detection paths L1 to L8, each of which extends linearly between the connector 31 and the monitoring IC 30. The present disclosure may however not be limited to the above configuration. Specifically, as illustrated in FIG. 13, detection paths M1 to M8 may be used, each of which extends between the connector 31 and the monitoring IC 30.

A plurality of monitoring ICs may be arranged on one of the first and second surfaces of the circuit board 70. In this modification, the detection paths and the resistors, which are for example illustrated in FIG. 2, may be mounted for the respective monitoring ICs on one of the first and second surfaces of the circuit board 70.

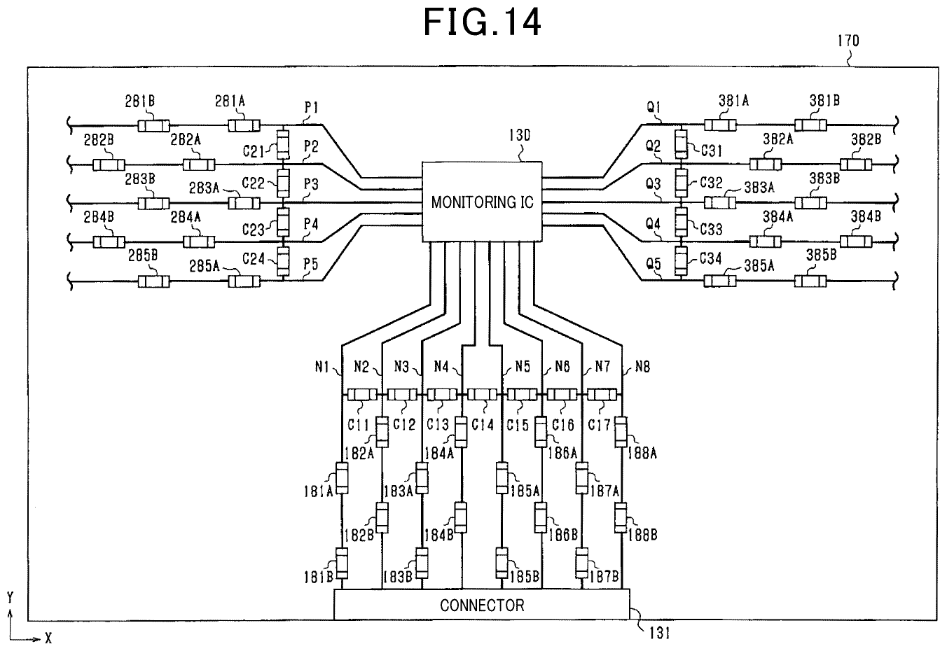

As illustrated as an example in FIG. 14, plural groups of detection paths connected to a monitoring IC 130 may be provided. In the example configuration illustrated in FIG. 14, the illustration of terminals of the monitoring IC 130 is omitted for the sake of simple illustration.

In the example configuration illustrated in FIG. 14, a first group of detection paths N1 to N8 are mounted on the first surface of a circuit board 170, each of which extends from the monitoring IC 130 to the connector 131 in the Y direction. A second group of detection paths P1 to P5 are mounted on the first surface of the circuit board 170, each of which extends from the monitoring IC 130 to a first end of the circuit board 170 in the X direction. A third group of detection paths Q1 to Q5 are mounted on the first surface of the circuit board 170, each of which extends from the monitoring IC 130 to a second end of the circuit board 170, which opposite to the first end, in the X direction. The illustration of the middle of each of the detection paths P1 to P5 and Q1 to Q5 from the middle onward is omitted in FIG. 14.

For the detection paths N1 to N8 of the first group, first-A to eighth-A resistors 181A to 188A, first-B to eighth-B resistors 181B to 188B, and first to seventh capacitors C11 to C17 are mounted on the first surface of the circuit board 170. Similarly, for the detection paths P1 to P5 of the second group, first-A to fifth-A resistors 281A to 285A, first-B to fifth-B resistors 281B to 285B, and first to fourth capacitors C11 to C14 are mounted on the first surface of the circuit board 170. For the detection paths Q1 to Q5 of the third group, first-A to fifth-A resistors 381A to 385A, first-B to fifth-B resistors 381B to 385B, and first to fourth capacitors C31 to C34 are mounted on the first surface of the circuit board 170.

For each combination of two adjacent detection paths selected from all the detection paths according to each of the first to seventh embodiments, the center position of the resistor mounted on one of the two adjacent detection paths is arranged to be offset relative to the center position of the resistor mounted on the other of the two adjacent detection paths. The present disclosure is, however, not limited to the above configuration. Specifically, for at least one combination of two adjacent detection paths selected from all the detection paths according to each of the first to seventh embodiments, the center position of the resistor mounted on one of the two adjacent detection paths may be arranged to be offset relative to the center position of the resistor mounted on the other of the two adjacent detection paths.

The battery monitoring apparatuses and methods described in the present disclosure can be implemented by a dedicated computer including a memory and a processor programmed to perform one or more functions embodied by one or more computer programs.

The battery monitoring apparatuses and methods described in the present disclosure can also be implemented by a dedicated computer including a processor comprised of one or more dedicated hardware logic circuits.

The battery monitoring apparatuses and methods described in the present disclosure can further be implemented by a processor system comprised of a memory, a processor programmed to perform one or more functions embodied by one or more computer programs, and one or more hardware logic circuits.

The one or more computer programs can be stored in a non-transitory storage medium as instructions to be carried out by a computer or a processor.

While illustrative embodiments of the present disclosure have been described herein, the present disclosure is not limited to the embodiments described herein or disclosed configurations, but includes various modifications and adaptations and/or alternations within the equivalent scope of the descriptions. Additionally, various combinations, embodiments, combinations to which only one element or plural elements have been added, or modified embodiments to which only one element or plural elements have been added are within the category or scope of the present disclosure.

The following describes characteristic configurations extracted from the above embodiments.

### Configuration 10

A battery monitoring apparatus (10) according to the configuration 1 is to monitor a state of unit batteries (B1 to B7) connected in series. The battery monitoring apparatus includes a circuit board (70, 170), and a monitoring IC (30, 130) mounted on the circuit board and configured to monitor a state of each of the unit batteries. The battery monitoring apparatus includes a plurality of detection paths (L1 to L8, M1 to M8, N1 to N8, P1 to P5, Q1 to Q5) mounted on the circuit board. The detection paths electrically connect the respective unit batteries to the monitoring IC.

The battery monitoring apparatus includes at least one resistor (51 to 58, 81A to 88A, 81B to 88B, 181A to 188A, 181B to 188B, 281A to 285A, 281B to 285B, 381A to 385A, 381B to 385B) mounted on each detection path. The battery monitoring apparatus includes a plurality of discharge switches (SW1 to SW7), each of which is arranged to connect between a corresponding adjacent pair of the detection paths. The discharge switches are located to be closer to the monitoring IC than the at least one resistor is.

Each of the detection paths is arranged to extend from the monitoring IC to an edge of the circuit board. For at least one combination of two adjacent detection paths selected from all the detection paths, a center position of the at least one resistor mounted on one of the two adjacent detection paths is arranged to be offset relative to a center position of the at least one resistor mounted on the other of the two adjacent detection paths in a specific direction. The specific direction is defined as a direction from the monitoring IC toward the edge of the circuit board.

### Configuration 2

In the battery monitoring apparatus of the configuration 2, which depends from the configuration 1, for each combination of the two adjacent detection paths selected from all the detection paths, the center position of the at least one resistor mounted on one of the two adjacent detection paths is arranged to be offset relative to the center position of the at least one resistor mounted on the other of the two adjacent detection paths in the specific direction.

### Configuration 3

In the battery monitoring apparatus of the configuration 3, which depends from the configuration 2, for each combination of the two adjacent detection paths selected from all the detection paths, a mount position of the at least one resistor mounted on one of the two adjacent detection paths is non-overlapping with a mount portion of the at least one resistor mounted on the other of the two adjacent detection paths in a direction that is perpendicular to the specific direction along a selected surface of the circuit board.

### Configuration 4

In the battery monitoring apparatus of the configuration 3, which depends from any one of the configurations 1 to 3, the at least one resistor comprises at least two resistors (81A to 88A, 81B to 88B, 181A to 188A, 181B to 188B, 281A to 285A, 281B to 285B, 381A to 385A, 381B to 385B) mounted on each detection path.

### Configuration 5

In the battery monitoring apparatus of the configuration 5, which depends from the configuration 4, the at least two resistors mounted on each detection path include a near-side resistor (81A to 88A) and a far-side resistor (81B to 88B), the near-side resistor being located closer to the monitoring IC than the far-side resistor is. Each of the near-side resistor and the far-side resistor mounted on each detection path has a resistance value. The resistance value of the near-side resistor mounted on each detection path is set to be smaller than the resistance value of the far-side resistor mounted on the corresponding detection path.

### Configuration 6

A battery monitoring apparatus (10) according to the configuration 6 is to monitor a state of unit batteries (B1 to B7) connected in series. The battery monitoring apparatus includes a circuit board (70), and a monitoring IC (30) mounted on the circuit board and configured to monitor a state of each of the unit batteries. The battery monitoring apparatus includes a plurality of detection paths (L1 to L8) mounted on the circuit board. The detection paths electrically connect the respective unit batteries to the monitoring IC.

The battery monitoring apparatus includes at least two resistors (81A to 88A, 81B to 88B) mounted on each detection path and a plurality of discharge switches (SW1 to SW7), each of which is arranged to connect between a corresponding adjacent pair of the detection paths. The discharge switches are located to be closer to the monitoring IC than the at least two resistors are. The at least two resistors mounted on each detection path include a near-side resistor (81A to 88A) and a far-side resistor (81B to 88B). The near-side resistor is located closer to the monitoring IC than the far-side resistor is. Each of the near-side resistor and the far-side resistor mounted on each detection path has a resistance value. The resistance value of the near-side resistor mounted on each detection path is set to be smaller than the resistance value of the far-side resistor mounted on the corresponding detection path.

### Configuration 7

In the battery monitoring apparatus of the configuration 7, which depends from any one of the configurations 4 to 6, the circuit board has opposing first and second surfaces. The far-side resistors (81A to 88A) mounted on the respective detection paths (L1 to L8) and the monitoring IC are mounted on the first surface of the circuit board. The near-side resistors (81B to 88B) are mounted on the second surface of the circuit board.

### Configuration 8

The battery monitoring apparatus of the configuration 8, which depends from any one of the configurations 4 to 7, further includes a plurality of capacitors (C1 to C8), each of which is arranged to connect between a corresponding adjacent pair of the detection paths, the capacitors being located to be closer to the monitoring IC than the at least two resistors are. The at least two resistors mounted on each detection path have a total resistance value. The total resistance values of the detection paths are set to be substantially identical to one another; each of the capacitors has a capacitance value. The capacitance values of the capacitors are set to be substantially identical to one another.

### Configuration 9

In the battery monitoring apparatus of the configuration 9, which depends from any one of the configurations 1 to 6, the circuit board has opposing first and second surfaces. The at least one resistor (81A to 88A, 81B to 88B) on each detection path is mounted on the first surface of the circuit board. The monitoring IC is mounted on the second surface of the circuit board.

### Configuration 10

In the battery monitoring apparatus of the configuration 10, which depends from any one of the configurations 1 to 3, the at least one resistor (51 to 58) mounted on each detection path is a single resistor mounted on the corresponding detection path. The resistors mounted on the respective detection paths include near-side resistors (52, 54, 56, 58) and far-side resistors (51, 53, 55, 57). The near-side resistors are located closer to the monitoring IC than the far-side resistors are. Each of the near-side resistors and the far-side resistors has a resistance value. The resistance value of each of the near-side resistors is set to be smaller than the resistance value of each of the far-side resistors.

### Configuration 11

In the battery monitoring apparatus of the configuration 11, which depends from any one of the configurations 1 to 10, the unit batteries include a lowest-potential battery, a highest-potential battery, at least one odd-numbered unit battery countered from the lowest-or highest-potential battery, and at least one even-numbered battery countered from the lowest-or highest-potential battery. At least one of the discharge switches corresponding to the at least one odd-numbered unit battery is controlled to be turned on during a predetermined first period. At least an alternative one of the discharge switches corresponding to the at least one even-numbered unit battery is controlled to be turned on during a predetermined second period. The detection paths include outermost detection paths (L1, L8) and at least one middle detection path (L2 to L7) located between the outermost detection paths. Each of the outermost detection paths and the at least one middle detection path has a width. The width of the at least one middle detection path is greater than the width of each of the outermost detection paths.

1. A battery monitoring apparatus for monitoring a state of unit batteries connected in series, the battery monitoring apparatus comprising:
a circuit board;
a monitoring IC mounted on the circuit board and configured to monitor a state of each of the unit batteries;
a plurality of detection paths mounted on the circuit board, the detection paths electrically connecting the respective unit batteries to the monitoring IC;
at least one resistor mounted on each detection path; and
a plurality of discharge switches, each of which is arranged to connect between a corresponding adjacent pair of the detection paths, the discharge switches being located to be closer to the monitoring IC than the at least one resistor is,
wherein:
each of the detection paths is arranged to extend from the monitoring IC to an edge of the circuit board; and
for at least one combination of two adjacent detection paths selected from all the detection paths, a center position of the at least one resistor mounted on one of the two adjacent detection paths is arranged to be offset relative to a center position of the at least one resistor mounted on the other of the two adjacent detection paths in a specific direction, the specific direction being defined as a direction from the monitoring IC toward the edge of the circuit board.

2. The battery monitoring apparatus according to claim 1, wherein:
for each combination of the two adjacent detection paths selected from all the detection paths, the center position of the at least one resistor mounted on one of the two adjacent detection paths is arranged to be offset relative to the center position of the at least one resistor mounted on the other of the two adjacent detection paths in the specific direction.

3. The battery monitoring apparatus according to claim 2, wherein:
for each combination of the two adjacent detection paths selected from all the detection paths, a mount position of the at least one resistor mounted on one of the two adjacent detection paths is non-overlapping with a mount portion of the at least one resistor mounted on the other of the two adjacent detection paths in a direction that is perpendicular to the specific direction along a selected surface of the circuit board.

4. The battery monitoring apparatus according to claim 1, wherein:
the at least one resistor comprises at least two resistors mounted on each detection path.

5. The battery monitoring apparatus according to claim 4, wherein:
the at least two resistors mounted on each detection path include a near-side resistor and a far-side resistor, the near-side resistor being located closer to the monitoring IC than the far-side resistor is;
each of the near-side resistor and the far-side resistor mounted on each detection path has a resistance value; and
the resistance value of the near-side resistor mounted on each detection path is set to be smaller than the resistance value of the far-side resistor mounted on the corresponding detection path.

6. A battery monitoring apparatus for monitoring a state of unit batteries connected in series, the battery monitoring apparatus comprising:
a circuit board;
a monitoring IC mounted on the circuit board and configured to monitor a state of each of the unit batteries;
a plurality of detection paths mounted on the circuit board, the detection paths electrically connecting the respective unit batteries to the monitoring IC;
at least two resistors mounted on each detection path; and
a plurality of discharge switches, each of which is arranged to connect between a corresponding adjacent pair of the detection paths, the discharge switches being located to be closer to the monitoring IC than the at least two resistors are,
wherein:
the at least two resistors mounted on each detection path include a near-side resistor and a far-side resistor, the near-side resistor being located closer to the monitoring IC than the far-side resistor is;
each of the near-side resistor and the far-side resistor mounted on each detection path has a resistance value; and
the resistance value of the near-side resistor mounted on each detection path is set to be smaller than the resistance value of the far-side resistor mounted on the corresponding detection path.

7. The battery monitoring apparatus according to claim 4, wherein:
the circuit board has opposing first and second surfaces;
the far-side resistors mounted on the respective detection paths and the monitoring IC are mounted on the first surface of the circuit board; and
the near-side resistors are mounted on the second surface of the circuit board.

8. The battery monitoring apparatus according to claim 4, further comprising:
a plurality of capacitors, each of which is arranged to connect between a corresponding adjacent pair of the detection paths, the capacitors being located to be closer to the monitoring IC than the at least two resistors are;
the at least two resistors mounted on each detection path have a total resistance value;
the total resistance values of the detection paths are set to be substantially identical to one another;
each of the capacitors has a capacitance value; and
the capacitance values of the capacitors are set to be substantially identical to one another.

9. The battery monitoring apparatus according to claim 1, wherein:
the circuit board has opposing first and second surfaces;
the at least one resistor on each detection path is mounted on the first surface of the circuit board; and
the monitoring IC is mounted on the second surface of the circuit board.

10. The battery monitoring apparatus according to claim 1, wherein:
the at least one resistor mounted on each detection path is a single resistor mounted on the corresponding detection path; and
the resistors mounted on the respective detection paths include near-side resistors and far-side resistors, the near-side resistors being located closer to the monitoring IC than the far-side resistors are;
each of the near-side resistors and the far-side resistors has a resistance value; and
the resistance value of each of the near-side resistors is set to be smaller than the resistance value of each of the far-side resistors.

11. The battery monitoring apparatus according to claim 1, wherein:
the unit batteries include a lowest-potential battery, a highest-potential battery, at least one odd-numbered unit battery countered from the lowest-or highest-potential battery, and at least one even-numbered battery countered from the lowest-or highest-potential battery;
at least one of the discharge switches corresponding to the at least one odd-numbered unit battery is controlled to be turned on during a predetermined first period;
at least an alternative one of the discharge switches corresponding to the at least one even-numbered unit battery is controlled to be turned on during a predetermined second period;
the detection paths include outermost detection paths and at least one middle detection path located between the outermost detection paths;
each of the outermost detection paths and the at least one middle detection path has a width; and
the width of the at least one middle detection path is greater than the width of each of the outermost detection paths.
